(19) United States
(12) Patent Application Publication
(10) Pub. No.: US 2016/0239509 A1
(43) Pub. Date: Aug. 18, 2016

(54) FILE EXPLORER SYSTEM USABLE IN AN EMULATED INTEGRATED DEVELOPMENT ENVIRONMENT (IDE)

(71) Applicants: Gaurav Ahuja, Bangalore (IN); Anand Prakash, Bangalore (IN); Swetha Shetty, Bangalore (IN); Mahesh Maney, Bangalore (IN)

(72) Inventors: Gaurav Ahuja, Bangalore (IN); Anand Prakash, Bangalore (IN); Swetha Shetty, Bangalore (IN); Mahesh Maney, Bangalore (IN)

(73) Assignee: UNISYS CORPORATION, Blue Bell, PA (US)

(21) Appl. No.: 14/667,831

(22) Filed: Mar. 25, 2015

(30) Foreign Application Priority Data
Feb. 13, 2015 (IN) 420/DEL/2015

(51) Int. Cl. G06F 17/30

(52) U.S. Cl. CPC G06F 17/30106; G06F 17/30103

(57) ABSTRACT

A method and apparatus for a user-friendly file explorer usable in an emulated integrated development environment (IDE). The file explorer may allow users to perform functions within an emulated IDE that were previously unavailable. Such functions may include, for example, browsing a list of qualifiers, files and elements; opening multiple data files for viewing or editing; opening files having multiple file formats; converting Unicode characters; and filtering of listed qualifiers, files, and elements.

### FIELD OF THE DISCLOSURE

The instant disclosure relates to computer systems. More specifically, this disclosure relates to a file explorer system usable in an emulated integrated development environment (IDE).

### BACKGROUND

In conventional emulated environments, such as OS 2200 or other suitable environments, a user/developer may view and edit data files and elements in program files using a variety of editors provided by one or more hosts. Often, these editors do not provide a user interface, requiring the user to develop and edit the files from emulators or Green-Screens. With the widespread use of Microsoft Windows™ to access host systems, an Integrated Development Environment (IDE) for emulated environments may enable a user to access the editors using a Windows™-like user interface. The user interface may make it easier for developers to use while providing necessary features for developing applications over the hosts, like creating/viewing/editing/saving/deleting the elements, building projects and debugging source code. However, existing user interfaces may not have certain important functionalities, such as allowing a user to browse through a list of files, open a data file for viewing or editing, open multiple data files simultaneously, and filter search results and filenames, among other things. Thus, there is a desire for a file explorer view for an emulated IDE that would enable a user to perform these, and other, useful functionalities.

### SUMMARY

A user-friendly file explorer usable within an IDE is provided. In some embodiments, the file explorer executes a method comprising receiving a search term input comprising one or more of a filename, qualifier, and data element; displaying a list of browsable search results based on the search term; and opening one or more data files based on a selection of one or more of the search results. In some embodiments, the method further comprises determining the existence of a received qualifier; constructing a file path based on the search term input when the received qualifier exists; and declining to create the received qualifier when the received qualifier does not exist.

In some embodiments, the method further comprises receiving a wild-card input representing a filtering operation; and filtering the search results based on a combination of the wild-card input and the search term input. In some embodiments, the method further comprises receiving a search term input comprising a complete filename; and opening the data file corresponding to filename in the search term input, wherein the list of browsable search results remains unchanged from a receipt of prior search terms. In some embodiments, the method further comprises receiving a character conversion selection; and converting Unicode characters within the one or more opened data files based on the character conversion selection, wherein the character conversion selection corresponds to a human language. In some embodiments, the method further comprises creating a browsing history containing filenames of a number of recently opened data files; storing data from the one or more opened data files in a local cache; and retrieving the data from the local cache upon subsequent openings of the one or more opened data files. In some embodiments, the method further comprises receiving a search character input; and sorting the browsable search results based on the received search character input.

In some embodiments, the method further comprises determining a validity of the search term input; displaying an error message to a user when the search term input is invalid; and displaying a list of valid search terms selectable by the user. In some embodiments, the method allows multiple data files to be opened simultaneously based on the selection of multiple search results. In some embodiments, a file explorer view may be automatically minimized after opening the one or more data files. In some embodiments, the method further comprises the format of the search term input is one of a plurality of supported naming formats.

According to another embodiment, a computer program product may include a non-transitory computer-readable medium comprising code to perform the steps of receiving a search term input comprising one or more of a filename, qualifier, and data element; displaying a list of browsable search results based on the search term; and opening one or more data files based on a selection of one or more of the search results. The medium may also include code to perform the steps of determining the existence of a received qualifier; constructing a file path based on the search term input when the received qualifier exists; and declining to create the received qualifier when the received qualifier does not exist.

In some embodiments, the medium may also include code to perform the steps of receiving a wild-card input representing a filtering operation; and filtering the search results based on a combination of the wild-card input and the search term input. The medium may also include code to perform the steps of: receiving a search term input comprising a complete filename; and opening the data file corresponding to filename in the search term input, wherein the list of browsable search results remains unchanged from a receipt of prior search terms. The medium may also include code to perform the steps of receiving a character conversion selection; and converting Unicode characters within the one or more opened data files based on the character conversion selection, wherein the character conversion selection corresponds to a human language.

In some embodiments, the medium may also include code to perform the steps of creating a browsing history containing filenames of a number of recently opened data files; storing data from the one or more opened data files in a local cache; and retrieving the data from the local cache upon subsequent openings of the one or more opened data files. The medium may also include code to perform the steps of receiving a search character input; and sorting the browsable search results based on the received search character input. The medium may also include code to perform the steps of determining a validity of the search term input; displaying an error message to a user when the search term input is invalid; and displaying a list of valid search terms selectable by the user.

According to yet another embodiment, an apparatus may include a storage device, a memory, and a processor coupled to the memory and storage device. The processor may be configured to execute the steps of receiving a search term input comprising one or more of a filename, qualifier, and data element; displaying a list of browsable search results based on the search term; and opening one or more data files based on a selection of one or more of the search results. The processor may further be configured to execute the steps of determining the existence of a received qualifier; constructing a file path based on the search term input when the received qualifier exists; and declining to create the received qualifier when the received qualifier does not exist.

In some embodiments, the processor may further be configured to execute the steps of receiving a wild-card input representing a filtering operation; and filtering the search results based on a combination of the wild-card input and the search term input. The processor may further be configured to execute the steps of receiving a search term input comprising a complete filename; and opening the data file corresponding to filename in the search term input, wherein the list of browsable search results remains unchanged from a receipt of prior search terms. The processor may further be configured to execute the steps of receiving a character conversion selection; and converting Unicode characters within the one or more opened data files based on the character conversion selection, wherein the character conversion selection corresponds to a human language.

In some embodiments, the processor may further be configured to execute the steps of creating a browsing history containing filenames of a number of recently opened data files; storing data from the one or more opened data files in a local cache; and retrieving the data from the local cache upon subsequent openings of the one or more opened data files. The processor may further be configured to execute the steps of receiving a search character input; and sorting the browsable search results based on the received search character input. The processor may further be configured to execute the steps of determining a validity of the search term input; displaying an error message to a user when the search term input is invalid; and displaying a list of valid search terms selectable by the user.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an IDE architecture according to one embodiment of the disclosure.

FIG. 2 is a diagram illustrating an example of a IDE user interface according to one embodiment of the disclosure.

FIG. 3 is a diagram illustrating an example of a file explorer interface usable within the IDE user interface of FIG. 2 according to one embodiment of the disclosure.

FIG. 4 is a flow chart illustrating a method of accessing and opening one or more files according to one embodiment of the disclosure.

FIG. 5 is a flow chart illustrating a method of negating qualifier creation for a non-existent file path according to one embodiment of the disclosure.

FIG. 6 is a flow chart illustrating an intuitive response method according to one embodiment of the disclosure.

### DETAILED DESCRIPTION

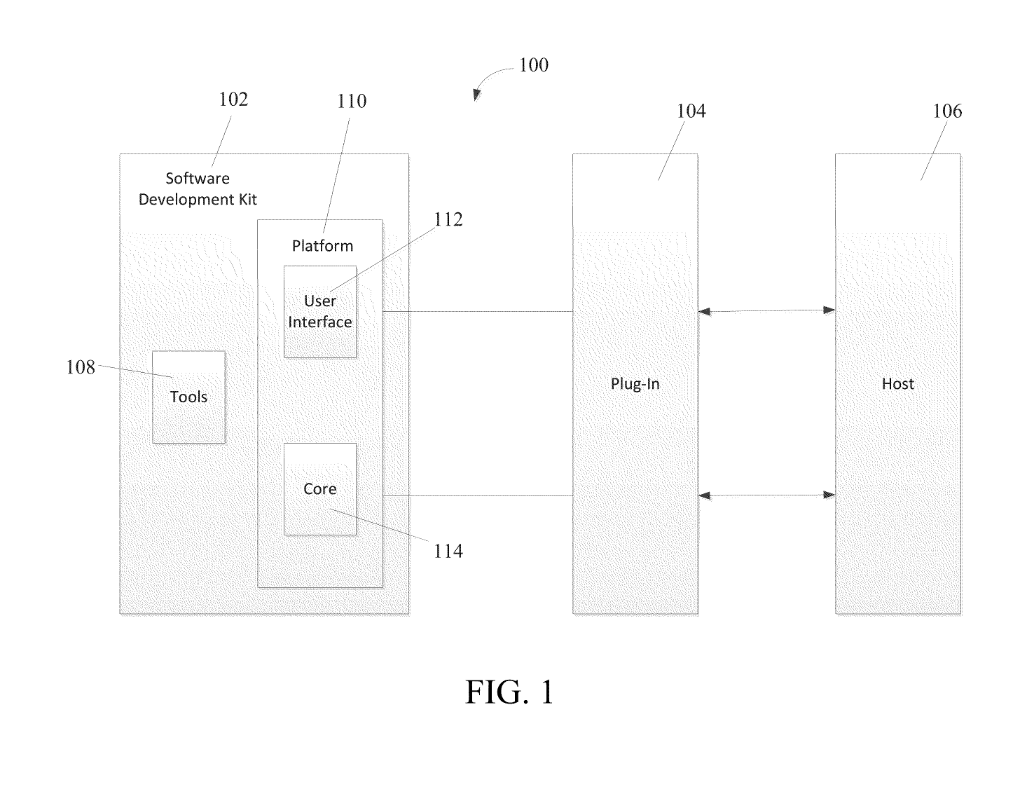

FIG. 1 illustrates one embodiment of an emulated IDE architecture 100 according to one embodiment of the disclosure. The architecture of IDE 100 may include a software development kit (SDK) 102, one or more plug-ins/modules 104, and one or more hosts/mainframes 106. SDK 102 may include various software development tools 108 that allow a user to create software applications. SDK 102 may also include a platform 110 that may include a user interface 112 and a core 114. A user may use user interface 112 to access tools 108 and plug-ins 104 that support a variety of different programming options. Plug-ins 104 may be open source and may provide additional functionalities in a variety of categories, including application management, build and deploy, graphics, profiling, and testing. Plug-ins 104 may also provide access to transactions and databases in one or more hosts 106. Platform 110 may enable development in many different programming languages, such as, for example, Java, COBOL, and PLUS. Platform 110 may also enable the use of various network protocols, such as, for example, TelNet.

A user may download SDK 102 and access platform 110 on a suitable processor-based device such as a desktop computer, a laptop computer, a personal digital assistant (PDA) or tablet computer, a smartphone or other mobile communication device. In some embodiments, the processor-based device may access a network to access a web application or web service hosted by mainframes 106 and enable the user to enter or receive information via user interface 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts, which permits two or more computers to communicate.

The applications of the present disclosure are not limited to IDE architecture 100 or any particular type of computer system. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, a computer system may be virtualized for access by multiple users and/or applications.

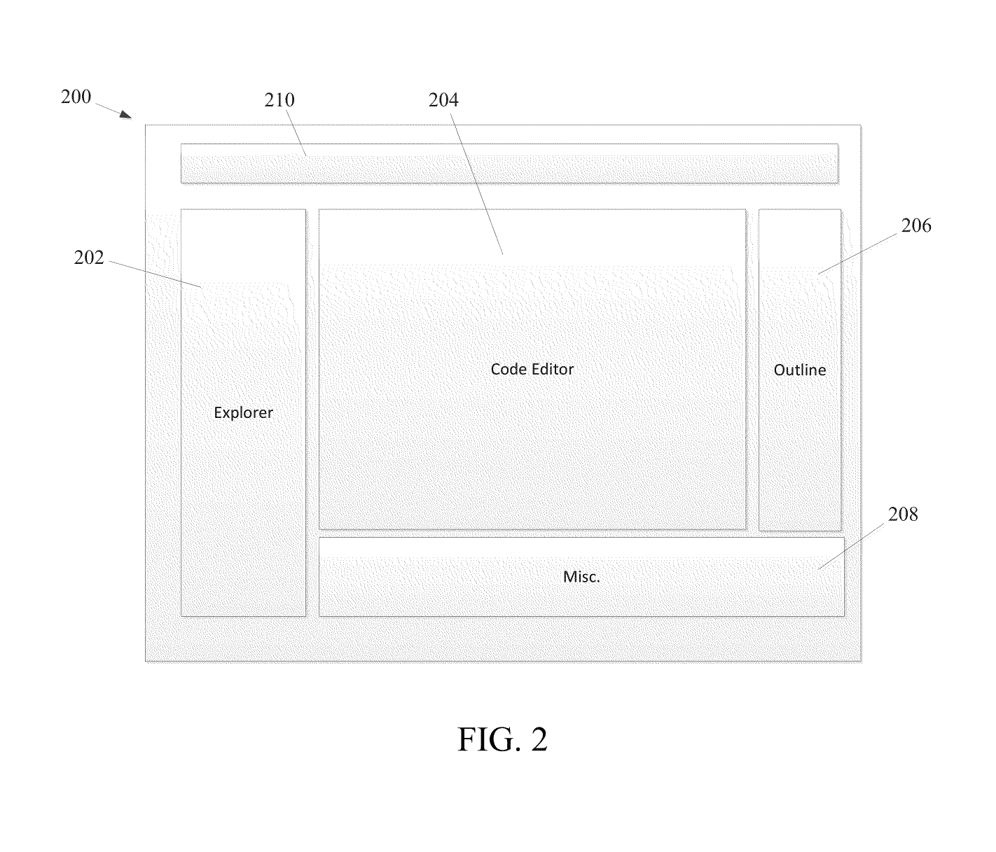

FIG. 2 illustrates an example of a perspective 200 of IDE user interface 112 according to one embodiment of the disclosure. Perspective 200 may comprise a view that allows the user to perform different development tasks. One or more windows 202, 204, 206, 208 may be provided, in various arrangements, to separate and organize various activities. These activities may comprise, for example, code editing, error checking, debugging, and searching. In the embodiment shown, perspective 200 comprises an explorer window 202, a code editor window 204, an outline window 206, and a miscellaneous or catch-all window 208. Windows 202, 204, 206, 208 may be linked together such that an action performed in one window may have an effect in one or more of the other windows. Each window may have minimize and full-screen buttons to allow the user to minimize the window or expand the window to a full-screen view, respectively. Perspective 200 may also comprise one or more menu bars or icons 210 to enable a user to perform various user interface functionalities.

In some embodiments, explorer window 202 may enable the user to view a structured view of a project and its objects. A project may comprise one or more application source files, a mechanism to edit the files, and a workfile that contains currently worked-on objects and pieces, such all or portions of application source code. Each project and object may be represented by icons in a hierarchical structure to allow the user to navigate to a particular project and object by selecting a corresponding icon.

In some embodiments, code editor window 204 may enable the user to view and edit a particular section of code. Code editor window 204 may include a tab selection area at the top of the window. The user may open multiple sections of code that are represented by tabs. The user may select a tab to work on a particular section of code and may move to other sections by toggling the tabs. The user may add and delete code in the editor window and save any changes.

In some embodiments, outline window 206 may enable the user to view a structured view of the file being currently edited. Major sections of code within the file may be represented by icons in a hierarchical structure to allow the user to navigate to a particular section of code within the file by selecting a corresponding icon. This functionality allows for quick navigation to key sections of code that may need multiple edits.

In some embodiments, catch-all window 208 may enable the user to view miscellaneous activities and notifications. Examples of activities include tasks, problems, properties, bookmarks, and errors. Catch-all window 208 may include a tab selection area at the top of the window having tabs that represent various tasks. The user may select a tab to work on a particular task. Due to linking between the windows, a selection made in catch-all window 208 may effect changes in one or more other windows. For example, the user may select a tab in catch-all window 208 to access an error log. If the user clicks on a particular error, code editor window 204 may display the line of code containing the problem so the user can make edits.

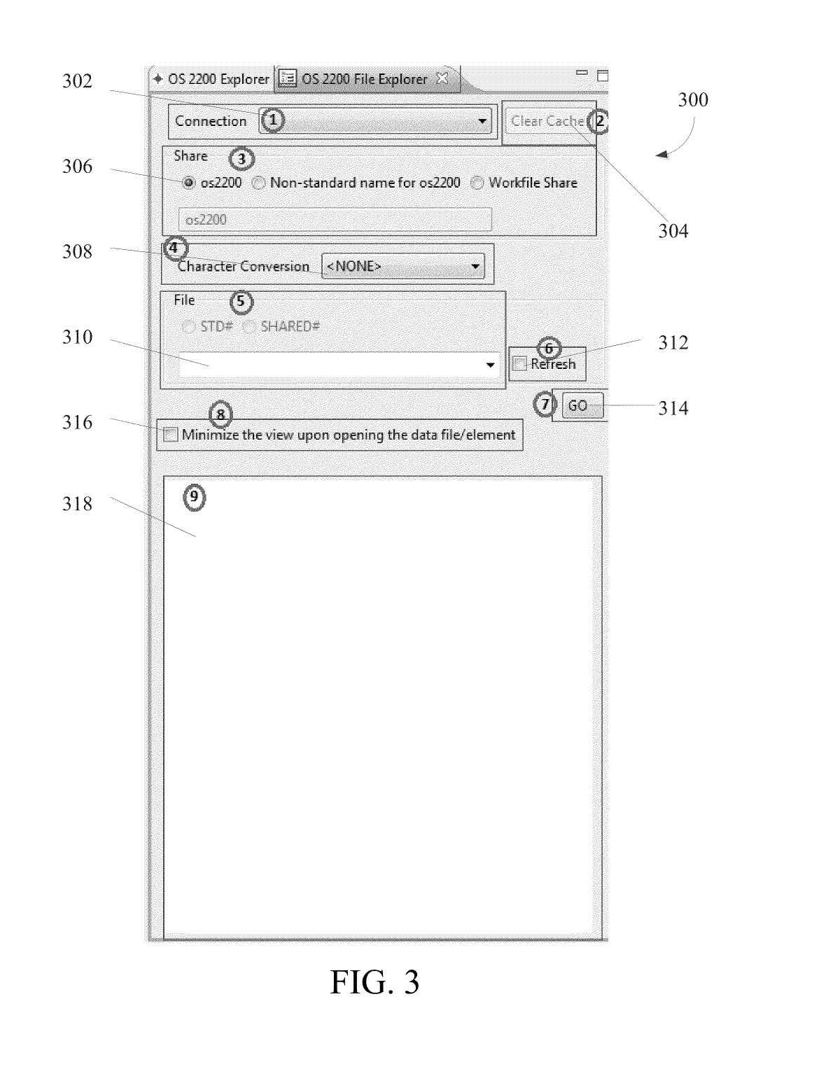

FIG. 3 is a block diagram illustrating an example of a file explorer interface 300 usable within the IDE user interface according to one embodiment of the disclosure. In the embodiment shown, file explorer interface 300 is displayed within explorer window 202. Explorer window 202 may include a tab selection area at the top of the window. The user may select a tab to toggle between an explorer view and a file explorer view. In the embodiment shown, file explorer interface 300 enables a user to perform various tasks such as, for example, file browsing, file-name filtering, multiple file opening, and Unicode character conversion.

In the embodiment shown, file explorer interface 300 comprises various fields, action selectors, and displays. These include, for example, a connection selection field 302, a clear cache button 304, a share option selection field 306, a character conversion selection field 308, a file search field 310, a refresh selection option 312, a function execution button 314, an automatic minimize selection option 316, and a list display field 318.

Connection selection field 302 may allow the user to connect to a particular host or mainframe. In the embodiment shown, connection selection field 302 comprises an uneditable drop-down menu. The menu contains a list of hosts that have been pre-configured with the IDE. The user may select a host name from the list to connect to that host. Clear cache button 304 may be selected by the user to clear any cached information for the selected host. Upon selection of clear cache button 304, the cache would be removed from the local file system and memory, ensuring that file data is initially retrieved from the host.

Share option selection field 306 may allow the user to choose a share option to determine a type of file and file location. In the embodiment shown, a radio-button for “os2200” is selected by default. If this option is selected, the text-box may display the text “os2200” and remain uneditable. A user may select this option to access files having standard IDE filenames. In the embodiment shown, if the user desires to access a file having a non-standard IDE filename or access a file from the workfile, the user may select an applicable radio-button to enable editing of the text-box. The user may then provide a valid share-name in the text-box.

Character conversion selection field 308 may allow the user to specify a character-conversion type. In the embodiment shown, a drop-down menu contains various character-conversion listings. The default value for this text-box may be derived from connection information stored by the user for the selected host. If a user opens a data file/element that contains Unicode, the user may select an option from the drop-down menu to convert the Unicode to script characters.

File search field 310 may allow a user to select a particular master file directory or enter a specific filename in a text box. In the embodiment shown, two radio buttons representing master file directories are provided. The user may configure the selected connection with an option for multi-host file sharing. In certain embodiments, if the user has configured this option, the radio buttons are enabled. In this situation, the “STD#” button is enabled by default to access a standard master file directory. However, the user may choose to select the “SHARED#” button to access a shared master file directory. In certain embodiments, when the user selects a radio button, the contents of that master file directory may be displayed in list display field 318.

Alternatively, in some embodiments, the user may specify a particular master file directory along with a filename in the text box. In this case, the selection of a radio button is overridden by the master file directory entered in the text box. For example, the “STD#” radio button may be selected by default. However, the user may wish to access the shared master file directory. Rather than select the “SHARED#” button, the user may enter the filename “SHARED#FILENAME*FILE” into the text box. This would automatically override the selected “STD#” button and access the file from the shared master file directory. In the embodiment shown, the text box also contains a drop-down option. A user may select the drop-down option to access a search history of recently entered filenames.

Refresh selection option 312 may allow the user to determine whether content will be read from the host or from a local cache. In the embodiment shown, the user may select a check box to enable the refresh option. Function execution button 314 may allow the user to trigger an action based on inputs provided in one or more fields of file explorer interface 300. In the embodiment shown, the user may select the GO button to trigger an action. Alternatively, the user may trigger an action by pressing the Enter key on a keyboard.

Automatic minimize selection option 316 may allow the user to enable automatic minimization of a view of file explorer interface 300. In the embodiment shown, the user may select a check box to automatically minimize the view of file explorer interface 300 upon opening a data file or element. This action may create additional space for code editor 204. List display field 318 may allow the user to view and interact with a list of entities based upon the inputs provided one or more fields of file explorer interface 300. The list of entities may correspond to one or more files and/or directories.

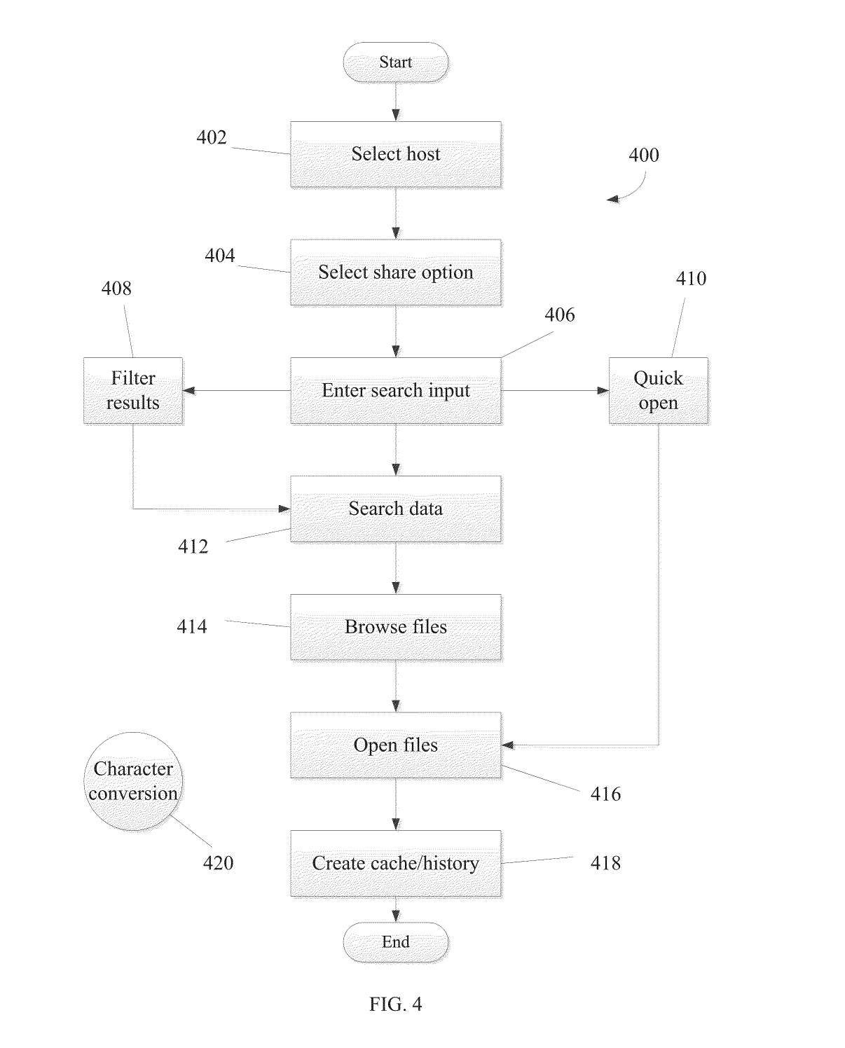

FIG. 4 is a flow chart illustrating a method of accessing and opening one or more files according to one embodiment of the disclosure. A method 400 may include, at block 402, receiving a host connection input from a user. In the embodiments shown, the user may select a host connection by opening the drop-down menu in connection selection field 302 and selecting a menu entry. At block 404, the method 400 may include selecting a share option. In the embodiments shown, the user may choose to keep a default selection or make a different selection in share option selection field 306. In instances where the user modifies the default selection, the user may have the option to enter a share-name in the text box of share option selection field 306.

At block 406, the method 400 may include entering a search input. In the embodiments shown, there are multiple ways a user may enter a search input. For example, the user may enter a full or partial qualifier, file path, filename, or wild-card character into the text box of file search field 310. Alternatively, the user may select an entry from a browsing history. Depending on the user's input, the user may enter a filter mode at block 408 or a quick open mode at block 410. In some embodiments, the user may also specify a file-cycle in addition to a filename to access a particular file cycle.

At block 408, method 400 may include filtering search results. In some cases, the user may not know the desired qualifier, file path, or filename he wishes to find. In this situation, the user may enter one or more wild-card characters into the text box to enter a filter mode and populate/filter a list of applicable search results. In the embodiments shown, the list of search results may be listed in list display field 318. In certain embodiments, multiple file input formats may be supported, such as, for example, a standard OS 2200 file format and a POSIX file format. For example, the user may specify a desired file input in the standard OS 2200 format (i.e. Qualifier*File.) or in the POSIX format (i.e. Qualifier\File\.). In the embodiment shown, all supported formats create and access the same cache over the local system as well as in the memory.

In some embodiments, three wild-card characters may be available to the user. A “%” wild-card may be used to locate a specific keyword at any position in a filename, including at the beginning of a word, in the middle of a word, and at the end of a word. A “?” wild-card may be used to represent a single character at a specific location; in some embodiments, multiple characters at the same location would not be returned For example, the search term “AS?” would locate words with “ASK” and “ASD” but not “ASDF.” A “˜” wild-card may be used to represent multiple characters at a specific location. In some embodiments, words beginning with letters to the left of the tilde and ending with letters to the right of the tilde will be returned. In some embodiments, words having additional letters before or after the letters on either side of the tilde will not be returned. For example, the search term “AS˜K” would locate the words “ASTERISK” and “ASOK” but would not locate “ASDFKL.”

At block 410, method 400 may include a quick open mode. In some cases, the user may know the complete filename he wishes to find and open. In this case, the user may input the complete filename. In the embodiment shown, the filename may be entered in the text box of file search field 310. Upon entry of the complete filename, the user may directly open that particular file. In the embodiment shown, the file is opened in code editor window 204. This functionality may be more efficient rather than requiring the user to browse through one or more directories and/or files that may be displayed in list display field 318. Use of quick open mode 410 may not disturb prior outputs displayed in list display field 318. For example, the user may enter a first partial filename in file search field 310 to display the items contained in that file in list display field 318. The user may then enter a complete filename to quick open that file in code editor window 204. The user may then interact with the items of the first file in list display field 318, which remain undisturbed by the second search, to open additional items in code editor window 204.

At block 412, the method 400 may include data searching. In the embodiment shown, search results are displayed in list display field 318 upon receipt of a search input. The user may interact with list display field 318 to further narrow his search. In some embodiments, the user may select an entry in list display field 318 and may key in additional terms. As the user keys in additional terms, items matching the additional terms are displayed. This may allow a user to navigate to an exact item entry and/or display the nearest matching item entries. For example, if the user keys in “FILE” as an additional term, the list navigates to all items that have that term in the filename (e.g., FILE, FILE1, FILE2, FILE3, etc.). The item entries may be sorted based on quality of the match. In the example above, the exact match “FILE” will be displayed first, and then “FILE.” “FILE2,” and so on. The search results may update in real-time as the user keys in additional terms.

At block 414, the method 400 may include file browsing. In the embodiment shown, search results are displayed in list display field 318 upon receipt of a search input. The user may interact with list display field 318 to find a desired file. The user may click on a particular directory or file to view its contents. As the user navigates through the files, the files and/or directories may be displayed in a hierarchical structure. In some embodiments, an “UP” operator (i.e., “..”) may be provided. This may allow a user to move to the next level up in the hierarchical structure.

At block 416, the method 400 may include file opening. In the embodiment shown, the user may open a file by selecting an entry in the list displayed in list display field 318. Alternately, the user may open a file by right-clicking over the desired entry and selecting “Open” from a context-menu. A user may open multiple files simultaneously in the same manner. In the embodiment shown, the files selected by the user are opened in code editor window 204 under individual tabs. The user may select the tab of a desired file to activate that file for editing. In the embodiment shown, the user is provided with an option to automatically minimize the view if a data file or an element is opened. In the embodiment shown, the user may enable this function by selecting automatic minimize selection option 316. If checked by the user, the view may minimize as soon as a data file or an element is opened, creating more space in code editor window 204. In this case, the user would need to maximize (or restore) opened files manually.

At block 418, the method 400 may include creating a cache and a browsing history. In the embodiment shown, as the user navigates through files, the file data may be initially retrieved from the applicable host and cached in local memory. Subsequent instances of accessing the file data would retrieve the data from the local cache rather than the host. In some embodiments, a list of elements for the files may be stored as a list in a local file system. This functionality may preserve host resources and make file searching more efficient. In the embodiment shown, the user may refresh the data in the cache by selecting refresh selection option 312. Alternatively, the user may delete the cache. In these instances, if cached data is not present, the data is retrieved from the host. In the embodiment shown, a browsing history is created as the user navigates through files. The browsing history may store 10 entries per host for file-paths that are successfully queried by the user. In some embodiments, the 10 entries may be the most recent files accessed by the user. In the embodiment shown, a user may open the browsing history by selecting a drop-down button in file search field 310.

At step 420, the method 400 may include Unicode character conversion. In the embodiment shown, the user may make a selection in character conversion selection field 308 to convert Unicode characters into a desired format. The format choices may correspond to various spoken and written languages such as Japanese, Chinese, German, etc. When the user opens a file, the file contents may be displayed in code editor window 204 in the chosen character conversion format. For example, if the user selects “Japanese” in character conversion selection field 308, a file containing English language terms may be converted to Japanese language characters.

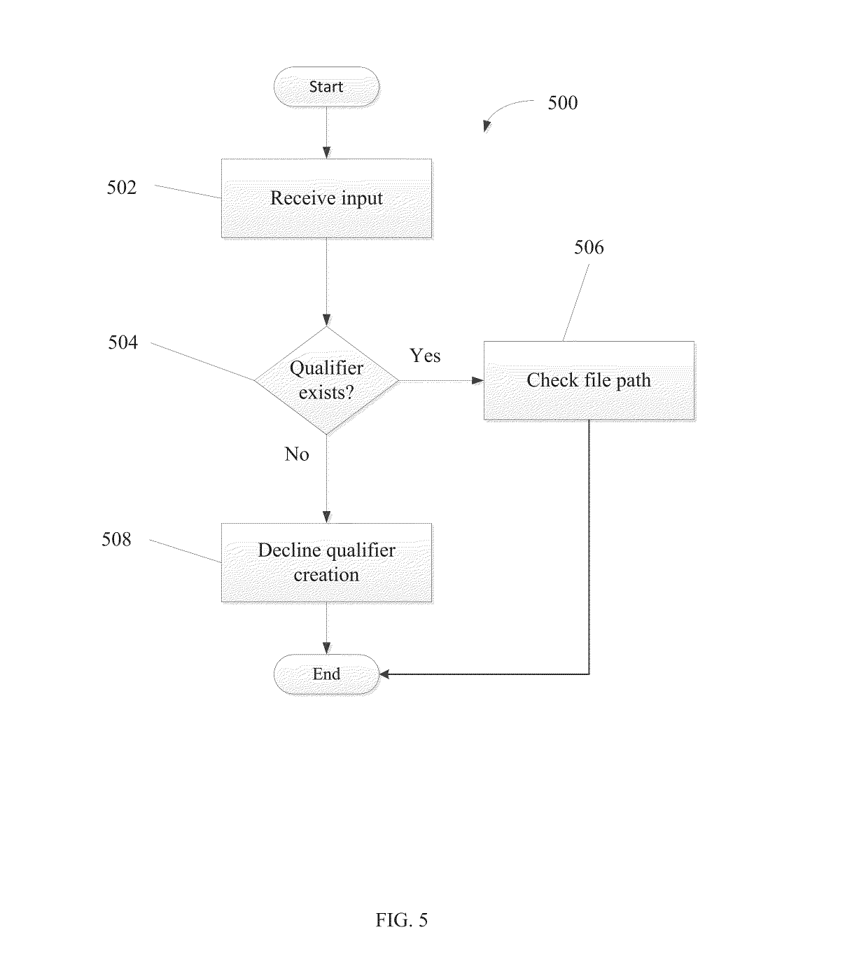

FIG. 5 is a flow chart illustrating a method of negating qualifier creation for a non-existent file path according to one embodiment of the disclosure. A method 500 may begin, at block 502, when a search input is received. A search input may be received in one or more methods previously discussed. At decision 504, a determination may be made whether a qualifier search input exists. In some file systems, a file-path that is beyond the qualifier level may be checked for existence. If the qualifier does not exist, the file system may first create the qualifier and then check for the rest of the file-path. This may result in the creation of an otherwise non-existent qualifier. In the embodiment shown, the system first checks for the existence of the qualifier in the input. If the qualifier exists, the method proceeds to block 506, where the system checks for the rest of the file-path. If the qualifier does not exist, the method proceeds to block 508. At this point, the file system declines to create the qualifier and returns an indication that the desired qualifier does not exist. This functionality may prevent the creation of qualifiers having no associated files.

For example, an input Qualifier*File.Element. may be entered by a user in file search field 310. A path may be constructed in POSIX format up to the desired qualifier (e.g., \\Host\Share\Qualifier.) and may be verified for its existence. If the file-path exists, the whole file-path is constructed based on the received input (e.g., \\Host\Share\Qualifier\File\Element.). If the complete file-path exists and represents a data file or an element, it may be opened in code editor window 204. If the file-path represents a program file, the element names may be displayed as a list in list display field 318. If the file-path doesn't exist, one node may be removed from the end of the complete file-path and queried for its existence. This step may repeat until the reducing path is found. The output for that path may be shown to the user accompanied by an error message regarding the original file-path.

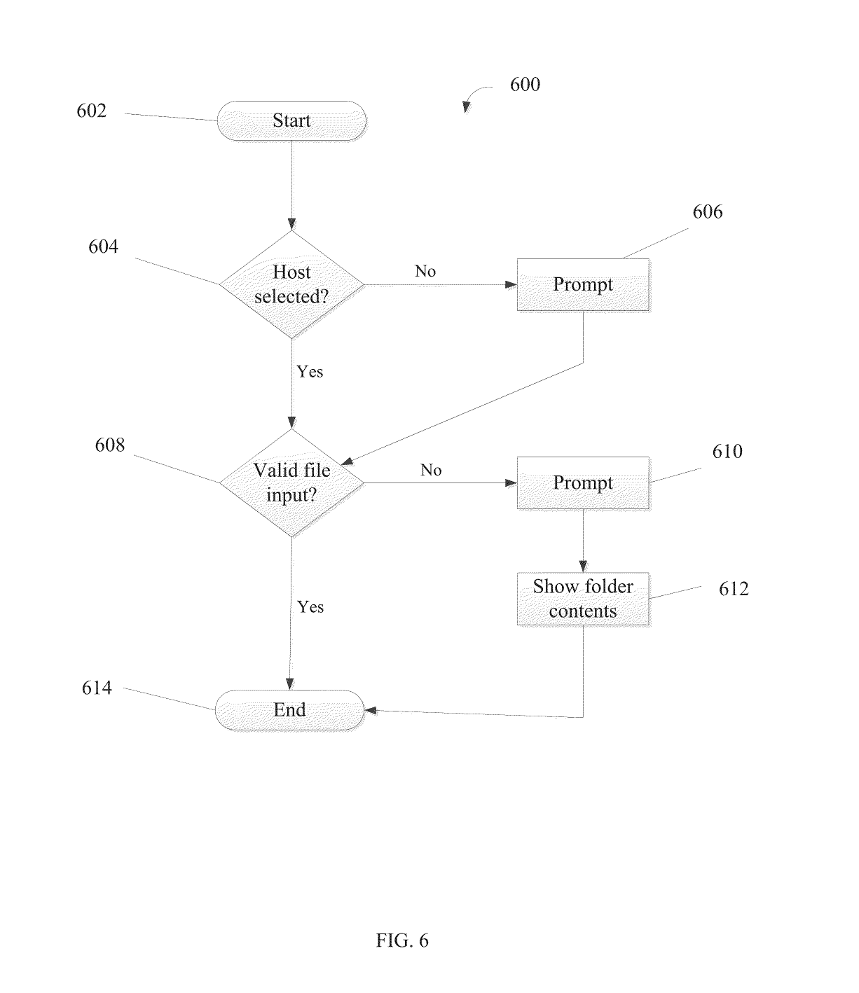

FIG. 6 is a flow chart illustrating an intuitive response process according to one embodiment of the disclosure. A method 600 may commence at block 602 and may, at decision 604, determine whether a host has been selected. If the user attempts to transmit a search query without entering a host input, the method may proceed to block 606. At block 606, the user may be shown a prompt that requests a host selection. The user may view the prompt and select a host.

After a host has been selected, the method 600 may commence to decision 608 to determine whether a valid file input has been received. If the user has entered an invalid input, the method may proceed to block 610. At block 610, the user may be shown a prompt that informs the user that the requested file doesn't exist and may request a valid input. At block 612, method 600 may display a list of possible file entities in list display field 318 to assist the user in finding a valid input.

In one example, a user may enter the invalid input “Qualifier*File.” The system may determine that the file doesn't exist and will show the user an error message and a list of file-names for the qualifier “Qualifier.” The user may then browse the list to find a valid file, such as “FILE.” In another example, an invalid file path may be entered. If the file-path is not correct, the path may be reduced by one node at a time to reach the first node that exists. A list of files at that node may be displayed along with an error-message for validating the input or selecting an entry from the displayed list. The user may then browse the list to find a valid file. In some embodiments, error messages may be shown as a balloon tool-tip over the erred component. The error messages may disappear when the user enters a valid input. Once the user enters a valid input, method 600 may end at block 614.

The schematic flow chart diagrams of FIGS. 4, 5, and 6 are generally set forth as logical flow chart diagrams. As such, the depicted order and labeled steps are indicative of one aspect of the disclosed methods. Other steps and methods may be conceived that are equivalent in function, logic, or effect to one or more steps, or portions thereof, of the illustrated methods. Additionally, the format and symbols employed are provided to explain the logical steps of the methods and are understood not to limit the scope of the methods. Although various arrow types and line types may be employed in the flow chart diagrams, they are understood not to limit the scope of the corresponding methods. Indeed, some arrows or other connectors may be used to indicate only the logical flow of the methods. For instance, an arrow may indicate a waiting or monitoring period of unspecified duration between enumerated steps of the depicted methods. Additionally, the order in which a particular method occurs may or may not strictly adhere to the order of the corresponding steps shown.

Those of skill would appreciate that the various illustrative logical blocks, modules, circuits, and algorithm steps described in connection with the disclosure herein may be implemented as electronic hardware, computer software stored on a computing device and executed by one or more processing devices, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

In some embodiments, the techniques or steps of a method described in connection with the aspects disclosed herein may be embodied directly in hardware, in software executed by a processor, or in a combination of the two. In some aspects of the disclosure, any software module, software layer, or thread described herein may comprise an engine comprising firmware or software and hardware configured to perform aspects of the described herein. In general, functions of a software module or software layer described herein may be embodied directly in hardware, or embodied as software executed by a processor, or embodied as a combination of the two. A software module may reside in RAM memory, flash memory, ROM memory. EPROM memory, EEPROM memory, registers, hard disk, a removable disk, a CD-ROM, or any other form of storage medium known in the art. An exemplary storage medium may be coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

While the aspects of the disclosure described herein have been described with reference to numerous specific details, one of ordinary skill in the art will recognize that the aspects of the disclosure can be embodied in other specific forms without departing from the spirit of the aspects of the disclosure. Thus, one of ordinary skill in the art would understand that the aspects described herein are not to be limited by the foregoing illustrative details, but rather are to be defined by the appended claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of exploring files within an integrated development environment, comprising:
receiving a search term input comprising one or more of a filename, qualifier, and data element;
displaying a list of browsable search results based on the search term; and
opening one or more data files based on a selection of one or more of the search results.

2. The method of claim 1, further comprising:
determining the existence of a received qualifier;
constructing a file path based on the search term input when the received qualifier exists; and
declining to create the received qualifier when the received qualifier does not exist.

3. The method of claim 1, further comprising:
receiving a wild-card input representing a filtering operation; and
filtering the search results based on a combination of the wild-card input and the search term input.

4. The method of claim 1, further comprising:
receiving a search term input comprising a complete filename; and
opening the data file corresponding to filename in the search term input,
wherein the list of browsable search results remains unchanged from a receipt of prior search terms.

5. The method of claim 1, further comprising:
receiving a character conversion selection; and
converting Unicode characters within the one or more opened data files based on the character conversion selection,
wherein the character conversion selection corresponds to a human language.

6. The method of claim 1, further comprising:
creating a browsing history containing filenames of a number of recently opened data files;
storing data from the one or more opened data files in a local cache; and
retrieving the data from the local cache upon subsequent openings of the one or more opened data files.

7. The method of claim 1, further comprising:
receiving a search character input; and
sorting the browsable search results based on the received search character input.

8. The method of claim 1, further comprising:
determining a validity of the search term input;
displaying an error message to a user when the search term input is invalid; and
displaying a list of valid search terms selectable by the user.

9. The method of claim 1, wherein multiple data files are opened simultaneously based on the selection of multiple search results.

10. The method of claim 1, wherein a file explorer view is automatically minimized after opening the one or more data files.

11. The method of claim 1, wherein the format of the search term input is one of a plurality of supported naming formats.

12. A computer program product, comprising:
a non-transitory computer-readable medium comprising code to perform the steps of:
receiving a search term input comprising one or more of a filename, qualifier, and data element;
displaying a list of browsable search results based on the search term; and
opening one or more data files based on a selection of one or more of the search results.

13. The computer program product of claim 12, the steps further comprising:
determining the existence of a received qualifier;
constructing a file path based on the search term input when the received qualifier exists; and
declining to create the received qualifier when the received qualifier does not exist.

14. The computer program product of claim 12, the steps further comprising:
receiving a wild-card input representing a filtering operation; and
filtering the search results based on a combination of the wild-card input and the search term input.

15. The computer program product of claim 12, the steps further comprising:
receiving a search term input comprising a complete filename; and
opening the data file corresponding to filename in the search term input,
wherein the list of browsable search results remains unchanged from a receipt of prior search terms.

16. The computer program product of claim 12, the steps further comprising:
receiving a character conversion selection; and
converting Unicode characters within the one or more opened data files based on the character conversion selection,
wherein the character conversion selection corresponds to a human language.

17. The computer program product of claim 12, the steps further comprising:
creating a browsing history containing filenames of a number of recently opened data files;
storing data from the one or more opened data files in a local cache; and
retrieving the data from the local cache upon subsequent openings of the one or more opened data files.

18. The computer program product of claim 12, the steps further comprising:
receiving a search character input; and
sorting the browsable search results based on the received search character input.

19. The computer program product of claim 12, the steps further comprising:
determining a validity of the search term input;
displaying an error message to a user when the search term input is invalid; and
displaying a list of valid search terms selectable by the user.

20. The computer program product of claim 12, wherein multiple data files are opened simultaneously based on the selection of multiple search results.

21. The computer program product of claim 12, wherein a file explorer view is automatically minimized after opening the one or more data files.

22. The computer program product of claim 12, wherein the format of the search term input is one of a plurality of supported naming formats.

23. An apparatus, comprising:
a network interface card (NIC);
a memory; and
a processor coupled to the memory and to the network interface card (NIC), the processor configured to execute the steps of:
receiving a search term input comprising one or more of a filename, qualifier, and data element;
displaying a list of browsable search results based on the search term; and
opening one or more data files based on a selection of one or more of the search results.

24. The apparatus of claim 23, the steps further comprising:
determining the existence of a received qualifier;
constructing a file path based on the search term input when the received qualifier exists; and
declining to create the received qualifier when the received qualifier does not exist.

25. The apparatus of claim 23, the steps further comprising:
receiving a wild-card input representing a filtering operation; and
filtering the search results based on a combination of the wild-card input and the search term input.

26. The apparatus of claim 23, the steps further comprising:
receiving a search term input comprising a complete filename; and
opening the data file corresponding to filename in the search term input,
wherein the list of browsable search results remains unchanged from a receipt of prior search terms.

27. The apparatus of claim 23, the steps further comprising:
receiving a character conversion selection; and
converting Unicode characters within the one or more opened data files based on the character conversion selection,
wherein the character conversion selection corresponds to a human language.

28. The apparatus of claim 23, the steps further comprising:
creating a browsing history containing filenames of a number of recently opened data files;
storing data from the one or more opened data files in a local cache; and
retrieving the data from the local cache upon subsequent openings of the one or more opened data files.

29. The apparatus of claim 23, the steps further comprising:
receiving a search character input; and
sorting the browsable search results based on the received search character input.

30. The apparatus of claim 23, the steps further comprising:
determining a validity of the search term input;
displaying an error message to a user when the search term input is invalid; and
displaying a list of valid search terms selectable by the user.

31. The apparatus of claim 23, wherein multiple data files are opened simultaneously based on the selection of multiple search results.

32. The apparatus of claim 23, wherein a file explorer view is automatically minimized after opening the one or more data files.

33. The apparatus of claim 23, wherein the format of the search term input is one of a plurality of supported naming formats.
